(19) United States
(12) Patent Application Publication
(10) Pub. No.: US 2009/0083373 A1
(43) Pub. Date: Mar. 26, 2009

(54) PUBLICIZED INFORMATION USE APPARATUS, PUBLICIZED INFORMATION USE METHOD, AND COMPUTER PROGRAM PRODUCT

(75) Inventors: Kazuo MATOBA, Akashi-shi (JP); Yasuji Takeuchi, Kobe-shi (JP); Tomoyuki Okamoto, Suita-shi (JP); Tomo Tsuboi, Itami-shi (JP); Yoshinori Sugahara, Kyoto-shi (JP); Satoshi Deishi, Ibaraki-shi (JP); Kagumi Moriwaki, Kawanishi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/211,281

(22) Filed: Sep. 16, 2008

(30) Foreign Application Priority Data
Sep. 21, 2007 (JP) 2007-245965

(51) Int. Cl. G06F 15/16

(52) U.S. Cl. 709/203

(57) ABSTRACT

An image forming device 1 is provided with: a setting information storage portion 1K1 that stores root processing setting information DTR indicating a method by which each piece of RSS data is to be used after being obtained; a download processing portion 102 that downloads RSS data from a server; and a post-processing portion 107 that executes post-processing, which is processing for using the downloaded RSS data, based on the root processing setting information DTR of that RSS data, stored in the setting information storage portion 1K1.

This application is based on Japanese patent application No. 2007-245965 filed on Sep. 21, 2007, the contents of which are hereby incorporated by reference.

### BACKGROUND OF THE INVENTION

1. Field of the Invention

The present invention relates to an apparatus, a method, and the like for using information publicized through a web server or the like on the Internet.

2. Description of the Related Art

Web servers on the Internet were initially used primarily for publicizing academic information. However, in recent years, such servers are being used to publicize information that has an update frequency much higher than that of academic information, such as news flashes, new product announcements, traffic information, weather information, weblogs, and so on.

Users tend to overlook information that is updated at high frequency. As a response to this, methods for efficiently preventing such overlooks have been proposed, such as the method described in JP 2003-288262A. According to this method, when a homepage update detection means detects that a homepage has been updated, the update time of homepage information associated with the homepage and an access time for user information are read out from a storage means they are stored in and compared by a notification means; the notification means communicates the update to the user corresponding to the user information if the access time is more recent than the update time.

However, the method described in JP2003-288262A simply notifies the user that information has been updated. The user must therefore access the web server each time s/he receives a notification and obtains the information thereby, which is a troublesome process.

### SUMMARY

Having been conceived in light of the abovementioned problem, it is an object of an embodiment of the present invention to enable a user to obtain and use information publicized through a web server or the like more efficiently than is conventionally possible.

A publicized information use apparatus according to an aspect of the present invention is a publicized information use apparatus for using publicized information that is information publicized through a server. The publicized information use apparatus includes a storage portion that stores usage method information indicating a method by which each piece of the publicized information is to be used after being obtained, an obtainment portion that obtains the publicized information from the server, and a usage processing portion that executes usage processing based on the usage method information for the publicized information stored in the storage portion, the usage processing being processing for using the publicized information obtained by the obtainment portion.

Preferably, the usage processing portion may execute, as the usage processing, at least one of processing for forwarding the publicized information to a predetermined destination, processing for uploading the publicized information to a second server that manages information shared among a plurality of users, and processing for printing the publicized information onto paper.

Further, the publicized information use apparatus may further include a determination portion that determines whether or not content that has been updated or added is included in the publicized information obtained by the obtainment portion. The usage processing portion may execute the usage processing in the case where the determination portion has determined that content that has been updated or added is included in the publicized information.

Further, the usage processing portion may execute the usage processing only for content that has been updated or added, from among the content included in the publicized information. The publicized information may be written in an RSS format.

According to the structure described above, it is possible for a user to obtain and use information publicized through a web server or the like more efficiently than is conventionally possible.

### BRIEF DESCRIPTION OF THE DRAWINGS

FIG. 1 is a diagram illustrating an example of a hardware configuration of an image forming device.

FIG. 2 is a diagram illustrating a functional configuration of an image forming device.

FIG. 3 is a diagram illustrating an example of a relationship of connections between an image forming device and other devices.

FIG. 4 is a diagram illustrating an example of RSS data.

FIG. 5 is a diagram illustrating an example of a list of items reproduced based on RSS data.

FIG. 6 is a diagram illustrating an example of root processing setting information.

FIG. 7 is a diagram illustrating an example of link destination processing setting information.

FIG. 8 is a diagram illustrating an example of a root RSS processing setting screen.

FIG. 9 is a diagram illustrating a relationship between root RSS data and RSS data and web pages below the root RSS data.

FIG. 10 is a diagram illustrating an example of a link destination processing setting screen.

FIG. 11 is a diagram illustrating an example of the display of a message regarding an update or the like and a message prompting a user to make a selection.

FIG. 12 is a diagram illustrating an example of a configuration of a post-processing portion.

FIG. 13 is a flowchart illustrating an example of the flow of setting processing.

FIG. 14 is a flowchart illustrating an example of the flow of notification processing and post-processing.

FIG. 15 is a flowchart illustrating an example of the flow of notification processing and post-processing.

FIG. 16 is a flowchart illustrating an example of the flow of processing for determining a usage method for RSS data or web pages.

### DESCRIPTION OF THE PREFERRED EMBODIMENTS

An image forming device 1, which functions as the publicized information use apparatus according to the present invention, is a device that integrates various functions, such as copying, scanning, faxing, document server (also known as a “box”) functions, and network printing (also known as “PC printing”). Such devices are also sometimes called MFPs, or Multi-Function Peripherals.

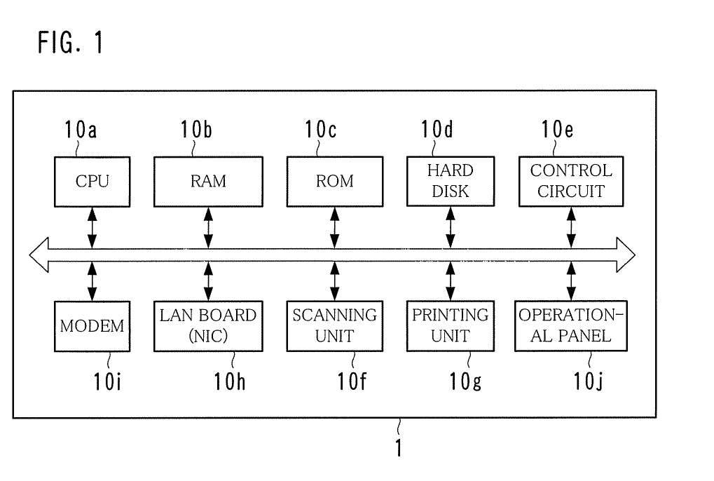

As shown in FIG. 1, the image forming device 1 is configured of a CPU 10a, a RAM 10b, a ROM 10c, a hard disk 10d, a control circuit 10e, a scanning unit 10f, a printing unit log, a LAN board 10h, a modem 10i, an operational panel 10j, and so on.

The control circuit 10e is a circuit for controlling the hard disk 10d, scanning unit 10f, printing unit 10g, LAN board 10h, modem 10i, operational panel 10j, and so on.

The scanning unit 10f optically reads an image of a document printed on paper, such as text, mathematical equations, symbols, photographs, diagrams, or illustrations, and generates image data thereof.

The printing unit log prints, onto paper, an image based on image data obtained by the scanning unit 10f or image data sent from a personal computer, a fax terminal, or the like.

The LAN board 10h is an NIC (Network Interface Card) for communicating with another device using a protocol such as TCP/IP. The modem 10i communicates with a fax terminal using a fax protocol, via a public line.

The operational panel 10j is a touch panel that displays screens such as a screen for providing messages or instructions to a user, a screen for the user to input the type of process s/he desires to be performed as well as processing conditions, a screen that displays the result of processes executed by the CPU 10a, and so on. The user can furthermore provide commands, specify processing conditions, and so on to the image forming device 1 by touching predetermined locations on the operational panel 10j. The operational panel 10j therefore serves as a user interface through which the user operates the image forming device 1.

The ROM 10c or hard disk 10d, serving as storage devices, store programs and data for implementing a setting details receiving portion 101, a download processing portion 102, an update presence/absence determination portion 103, an updated item notification processing portion 106, a post-processing portion 107, an execution status notification processing portion 108, a user information storage portion 1K0, a setting information storage portion 1K1, and a site data storage portion 1K2.

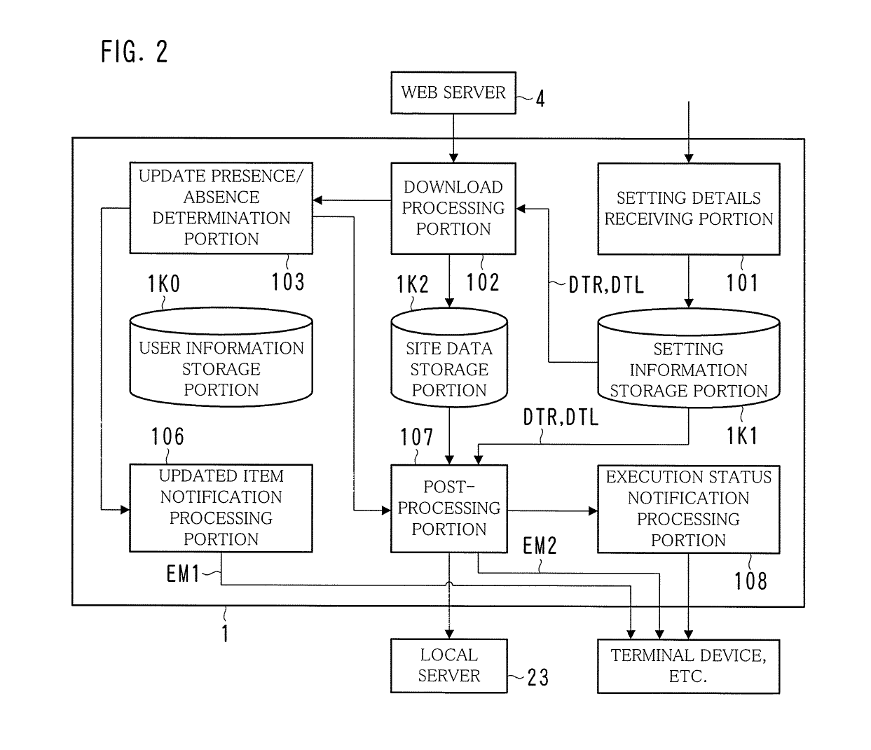

These programs and data are loaded into the RAM 10b as necessary, whereupon the programs are executed by the CPU 10a. Some or all of the functions shown in FIG. 2 may be implemented by a circuit such as the control circuit 10e.

The portions illustrated in FIG. 2 detect when a new item has been added to a website on the Internet or when such an item has been updated therein. Processing is then performed to notify the user when the items have been added or updated; then, processing that uses these items or information linked to the items is carried out. Hereinafter, the processing for notifying the user that an update has taken place shall be referred to as “notification processing”, whereas the processing that uses the information of the items shall be referred to as “post-processing”.

There are three methods that can be used for the post-processing: forwarding the information to a predetermined destination via e-mail; uploading the information to a local server 23; and printing the information onto paper. The notification processing and post-processing shall be described later.

The CPU 10a also executes other programs as appropriate, and performs overall control of the image forming device 1.

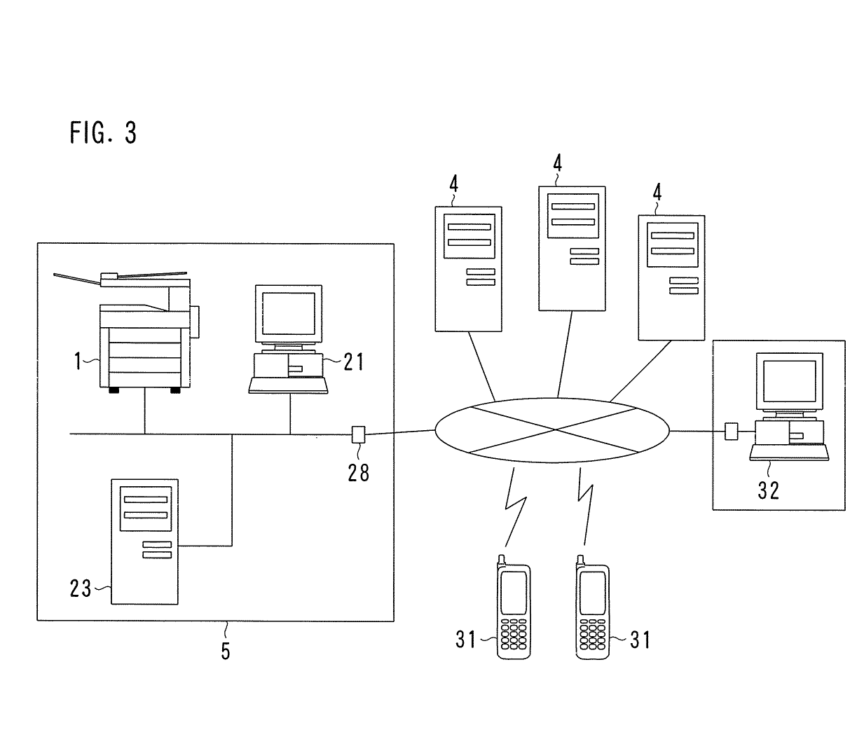

As shown in FIG. 3, the image forming device 1 is provided on an intranet 5 in an organization such as a public office, a business, a school, or the like. In addition to the image forming device 1, devices such as a terminal device 21, the local server 23, a router 28, and so on are provided on the intranet 5.

The local server 23 is a server that collectively manages information shared between members (users) of the organization. A web server, file server, or the like may be used as the local server 23. Alternatively, a groupware server may be used.

The terminal device 21 is a client of the image forming device 1, and is a device for utilizing the scanner, fax, box, and PC print functions of the image forming device 1. The terminal device 21 is also used as a client of the local server 23.

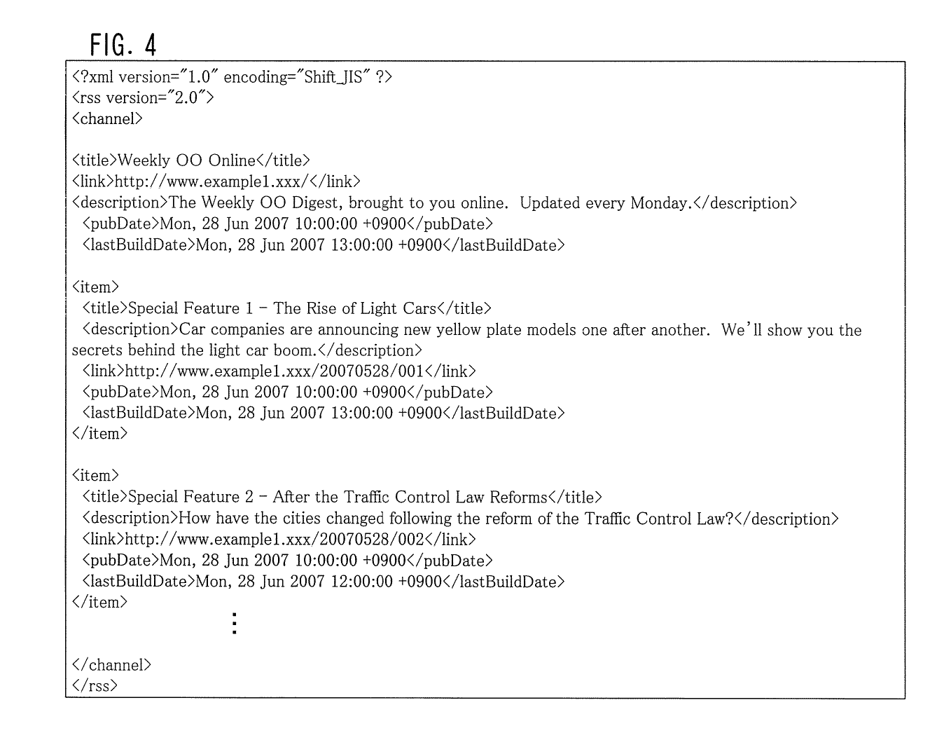

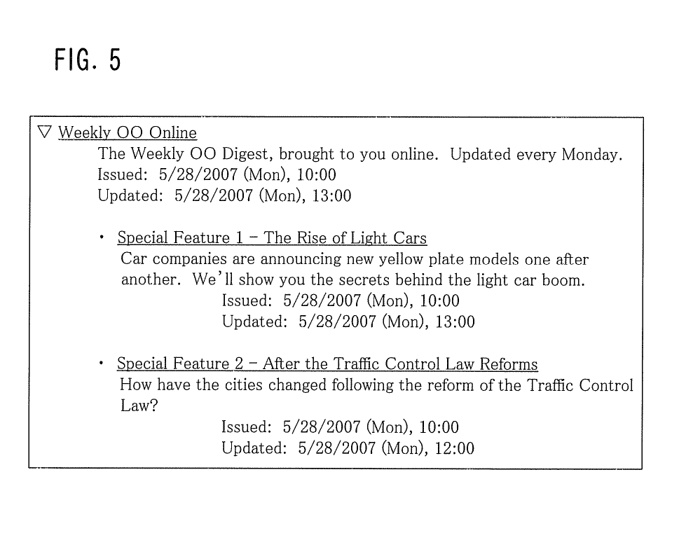

Furthermore, an e-mail application for creating and sending/receiving e-mail and a web browser are installed in the terminal device 21. An application for displaying a list of new items or updated items such as those shown in FIG. 5 based on RSS data such as that shown in FIG. 4 (in other words, an RSS reader) is also installed in the terminal device 21. A personal computer, workstation, PDA, or the like can be used as the terminal device 21.

The router 28 connects the intranet 5 to an external network such as the Internet. This makes it possible for the image forming device 1, terminal device 21, and local server 23 to communicate with a device outside of the intranet 5. For example, these devices can communicate with a web server 4 connected to the Internet, a mobile phone terminal 31 connected to a mobile phone network, or a terminal device 32 on another intranet connected to the Internet.

The mobile phone terminal 31 is a terminal device, used in mobile telephone communication, that is provided with an e-mail application, a web browser, and an RSS reader.

The terminal device 32 is, as described above, a terminal apparatus provided on an intranet different from the intranet 5. Like the terminal device 21, an e-mail application, a web browser, and an RSS reader are installed in the terminal device 32.

The web server 4 provides a web site configured of a single or plural web pages to a terminal device connected to the Internet. The web server 4 also provides data, written in RSS format (in other words, RSS data), of information such as the title (headline), summary, URL, date/time publicized, and the date/time of the last update for each item in the web site.

There are slight format differences for RSS depending on the version thereof, and the unabbreviated name can also be “RDF Site Summary”, “Rich Site Summary”, or “Really Simple Syndication”, depending on the version. However, the image forming device 1, terminal devices 21 and 32, mobile phone terminal 31, and web server 4 are compatible with any of the RSS versions.

Next, the details of processing performed by each of the portions of the image forming device 1 shown in FIG. 2 shall be described in detail.

Information indicating a user ID and e-mail address per user of the image forming device 1 is stored in the user information storage portion 1K0.

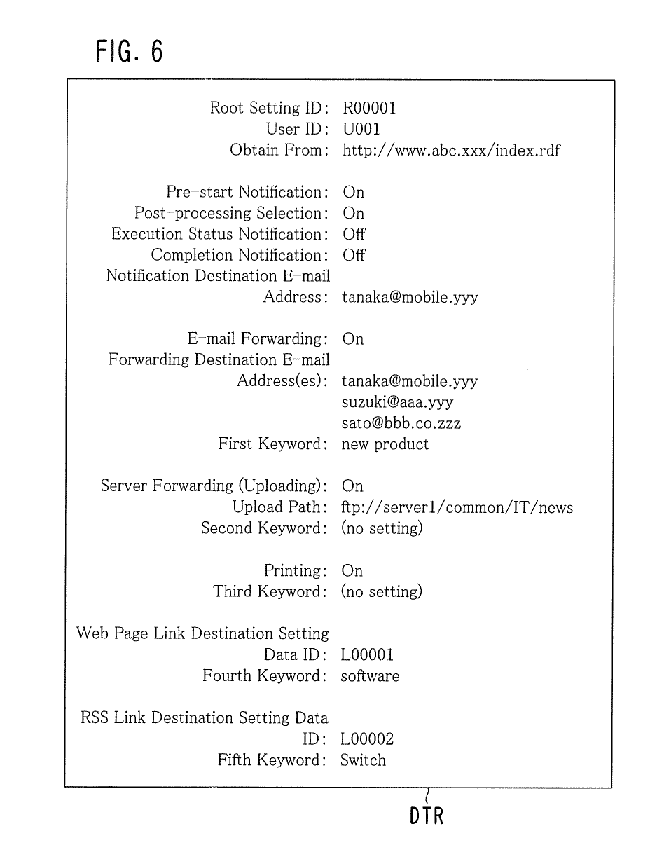

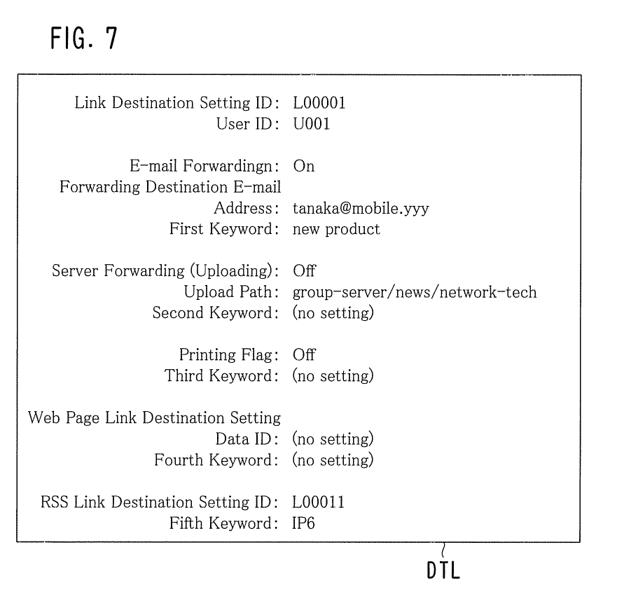

Root processing setting information DTR, such as that shown in FIG. 6, and link destination processing setting information DTL, such as that shown in FIG. 7, which indicate what sort of information is obtained from the web server 4 and how notification processing and post-processing are performed, are stored in the setting information storage portion 1K1.

The setting details receiving portion 101 receives details of settings regarding the obtainment of RSS data or web pages, notification processing, and post-processing, and performs the following processing for registering the root processing setting information DTR and link destination processing setting information DTL in the setting information storage portion 1K1.

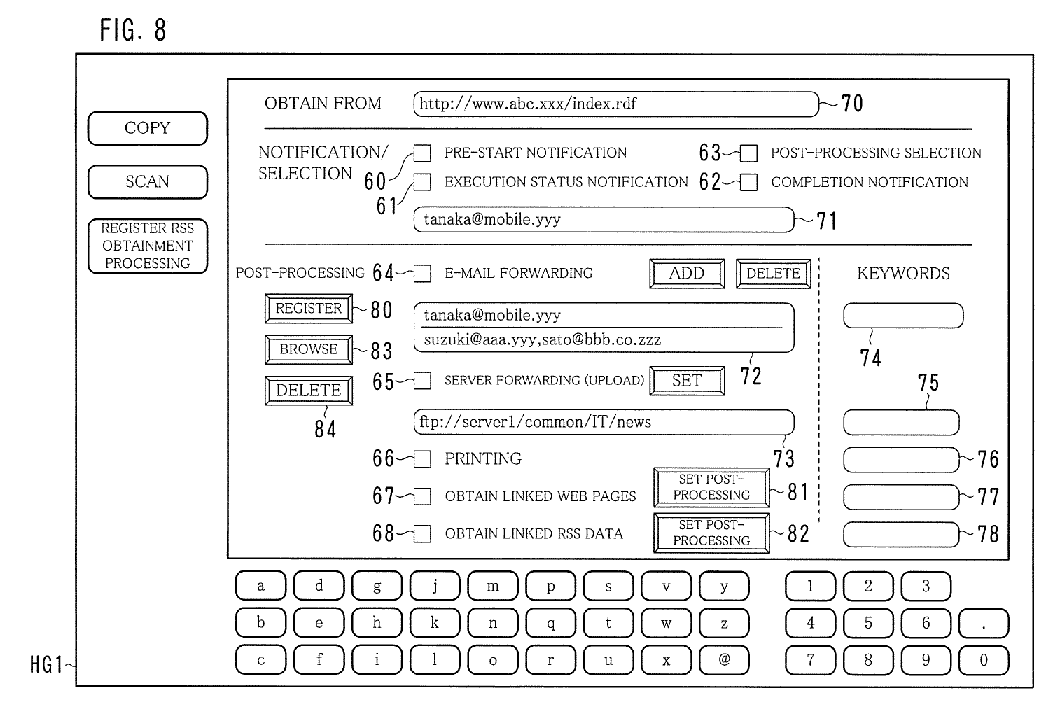

When a predetermined command is inputted after the user has logged onto the image forming device 1, the setting details receiving portion 101 causes the operational panel 10j to display a root RSS processing setting screen HG1 such as that shown in FIG. 8.

Here, the user inputs the URL of desired RSS data in a text box 70. This URL indicates the location of the RSS data on the Internet and the protocol used when obtaining the RSS data. The image forming device 1 can download the RSS data based on this URL.

Furthermore, the user decides in what manner s/he prefers the notification processing regarding this RSS data (in other words, the processing for providing notifications regarding updates of items indicated in the RSS data or the addition of information of new items to the RSS data) and the post-processing for this RSS data to be carried out, and performs the following operations.

The user inputs the e-mail address s/he wishes the notification to be sent to at the time of notification processing into a text box 71. If the user wishes to be notified of the start of post-processing in advance, s/he sets a check box 60 to “on”. If the user wishes to be notified of the status of the execution of the post-processing, s/he sets a check box 61 to “on”. Furthermore, if the user wishes to be notified of the completion of the post-processing, s/he sets a check box 62 to “on”. Finally, if the user wishes to select one of the three aforementioned post-processing methods prior to the execution of the post-processing, s/he sets a check box 63 to “on”.

In the case where the user wishes to carry out processing for forwarding this RSS data to someone through e-mail as the post-processing, s/he sets a check box 64 to “on” and inputs the e-mail address to which the data is to be forwarded into a text box 72. Plural e-mail addresses can also be inputted. Furthermore, the e-mail address of the user him/herself can also be inputted.

However, in the case where the user wishes to carry out processing for uploading this RSS data to the local server 23 as the post-processing, s/he sets a check box 65 to “on”, and inputs a URL indicating the path of the upload destination and the protocol to use when uploading into a text box 73.

Finally, in the case where the user wishes to carry out processing for printing the RSS data onto paper as the post-processing, s/he sets the check box 66 to “on”.

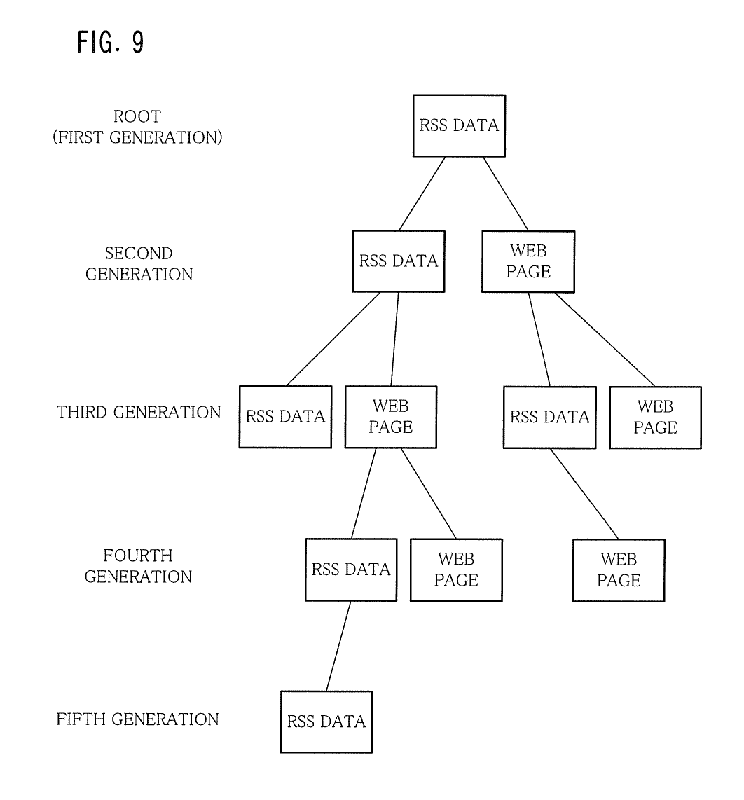

Incidentally, the user can perform settings regarding the use of web pages and RSS data linked to by hyperlinks included in the RSS data, and can furthermore perform settings regarding the use of web pages and RSS data linked to those web pages and RSS data. In other words, the user can perform settings regarding the use of other RSS data and web pages linked successively to the original RSS data, which serves as the root of a tree structure, as shown in FIG. 9. Hereinafter, the RSS data that serves as the root shall be referred to as “root RSS data” or “first-generation RSS data”. Furthermore, the RSS data and web pages below the root RSS data are referred to as “xth-generation RSS data”, “xth-generation web page”, and so on, with “x” representing the depth of the data or page.

Returning to the description of the root RSS processing setting screen HG1, in the case where both the web page and RSS data linked to by hyperlinks (the second-generation pages/data) included in this RSS data (the root RSS data) are not necessary, the user sets both check boxes 67 and 68 to “off”. Usage of the check boxes 67 and 68 shall be described later.

When a register button 80 is pressed when both check boxes 67 and 68 are “off”, the setting details receiving portion 101 receives the details inputted or specified through the root RSS processing setting screen HG1, and issues a unique root setting ID. Then, the root processing setting information DTR, such as that shown in FIG. 6, which indicates the issued root setting ID, the user ID of the user, and the received details, is generated and stored in the setting information storage portion 1K1.

It should be noted that, at the time of post-processing, rather than forwarding all the details of the RSS data through e-mail, uploading all the details of the RSS data to the local server 23, or printing all the details of the RSS data, the user can select and forward/upload/print only the details regarding desired items. In such a case, the user can input phrases indicating the desired items in the text boxes 74, 75, and 76, which correspond to the various methods, and which are located on the right side of the root RSS processing setting screen HG1. Hereinafter, there are situations where the keyword regarding e-mail forwarding, keyword regarding uploading, and keyword regarding printing are differentiated by denoting the keywords as a “first keyword”, “second keyword”, and “third keyword” respectively.

When a phrase to be used as a keyword is inputted, that phrase is set in the root processing setting information DTR. The root processing setting information DTR shown in FIG. 6 is an example in which only the phrase set as the first keyword, from among the first through third keywords, has been inputted and set.

Meanwhile, in the case where the user wishes to obtain a web page linked to by a hyperlink included in the root RSS data, or in other words, a second-generation web page, s/he sets the check box 67 to “on”. This makes a post-processing setting button 81 accessible; the user then presses that button.

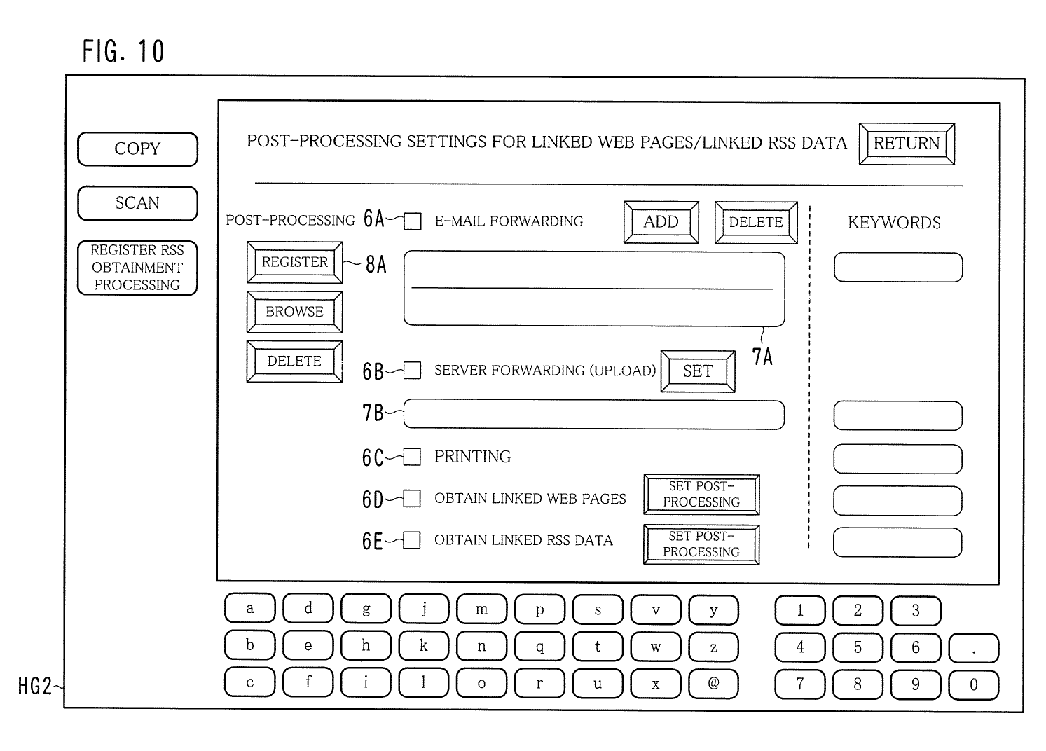

Then, the setting details receiving portion 101 causes a link destination processing setting screen HG2, such as that shown in FIG. 10, to be displayed in the operational panel 10j, in place of the root RSS processing setting screen HG1.

Here, the user sets the usage method of this web page to be almost identical to the usage method of the root RSS data, in the following manner.

In the case where this web page is to be forwarded through e-mail, the user sets a check box 6A to “on”, and inputs the e-mail address to which the web page is to be forwarded in a text box 7A. Plural e-mail addresses can be inputted here as well.

Furthermore, in the case where the web page is to be uploaded to the local server 23, the user sets a check box 6B to “on”, and inputs a URL indicating the path of the upload destination and the protocol to use when uploading into a text box 7B.

Finally, in the case where the web page is to be printed onto paper, the user sets a check box 6C to “on”.

When the user presses a register button 8A, the setting details receiving portion 101 receives the details inputted into the various text boxes and the on/off specification in the check boxes of the link destination processing setting screen HG2, and issues a unique link destination setting ID. Then, the link destination processing setting information DTL, which indicates the received details and the issued link destination setting ID, is generated and stored in the setting information storage portion 1K1.

The root RSS processing setting screen HG1 is then once again displayed in the operational panel 10j in place of the link destination processing setting screen HG2.

Next, when the user presses the register button 80, the setting details receiving portion 101 receives the details inputted or specified through the root RSS processing setting screen HG1, and issues a unique root setting ID. Then, the root processing setting information DTR, which indicates the issued root setting ID, the user ID of the user, the link destination setting ID of the generated link destination processing setting information DTL (the web page link destination setting data ID shown in FIG. 6), and the received details, is generated and stored in the setting information storage portion 1K1.

Alternatively, in the case where the user wishes to use the second-generation RSS data, s/he sets the check box 68 in the root RSS processing setting screen HG1 to “on”. This makes a post-processing setting button 82 accessible; the user then presses that button.

Next, the setting details receiving portion 101 performs the following processing in the same manner as when the post-processing setting button 81 has been pressed.

The link destination processing setting screen HG2, as shown in FIG. 10, is then displayed in the operational panel 10j in place of the root RSS processing setting screen HG1.

Here, the user sets the usage method of this RSS data to be almost identical to the usage method of the root RSS data, in the following manner. In other words, an e-mail address, URL of an upload destination, and necessity or lack thereof of printing are inputted or specified as required.

When the user presses the register button 8A, the setting details receiving portion 101 receives the details inputted into the various text boxes and the on/off specification in the check boxes, and issues a unique link destination setting ID. Then, the link destination processing setting information DTL, which indicates the received details and the issued link destination setting ID, is generated and stored in the setting information storage portion 1K1. The root RSS processing setting screen HG1 is then once again displayed in the operational panel 10j in place of the link destination processing setting screen HG2.

Next, when the user presses the register button 80, the setting details receiving portion 101 receives the details inputted or specified through the root RSS processing setting screen HG1, and issues a unique root setting ID. Then, the root processing setting information DTR, which indicates the issued root setting ID, the user ID of the user, the link destination setting ID of the generated link destination processing setting information DTL (the RSS link destination setting data ID shown in FIG. 6), and the received details, is generated and stored in the setting information storage portion 1K1.

In the case where the user performed settings regarding both the second-generation web page and RSS data, root processing setting information DTR indicating both the web page link destination setting data ID and the RSS link destination setting data ID is generated and registered.

It should be noted that rather than setting all details of the second-generation web page to be used, the user can select and set only the details regarding desired items to be used. In such a case, the user can input phrases indicating the desired items in a text box 77 located in the root RSS processing setting screen HG1. Similarly, regarding second-generation RSS data, the user can perform settings so that desired items are selected, by inputting phrases indicating the desired item in a text box 78.

The phrases respectively inputted into the text boxes 77 and 78 are set as fourth and fifth keywords in the root processing setting information DTR.

Furthermore, the user can perform settings regarding the use of a web page or RSS data linked to by hyperlinks included in second-generation web page or RSS data (in other words, third-generation page/data) through the link destination processing setting screen HG2.

In this case, as when using the root RSS processing setting screen HG1, the user sets check boxes 6D or 6E to “on” and presses a post-processing setting button.

Upon doing so, the setting details receiving portion 101 newly displays the link destination processing setting screen HG2 for performing settings regarding the usage of the third-generation web page or RSS data, and generates link destination processing setting information DTL for the third-generation web page or RSS data in accordance with the details inputted or specified by the user, similarly to as was performed for the origin of the link, or in other words, the second-generation web page or RSS data. Then, the root setting ID of the third-generation web page or RSS data (the web page link destination setting data ID or RSS link destination setting data ID) is set in the link destination processing setting information DTL of the web page or RSS data of the origin of the link.

By performing such operations successively as necessary, the user can perform settings regarding the usage of the root RSS data as well as web pages and other RSS data from the second generation on linked successively from the root RSS data as shown in FIG. 9.

As described thus far, settings regarding the usage of the root, or first-generation RSS data, are performed through the root RSS processing setting screen HG1. The details of those settings are then indicated in the root processing setting information DTR. Furthermore, the link destination setting ID of the link destination, or in other words, of the RSS data or web page of the following generation, is indicated in the root processing setting information DTR.

Meanwhile, settings regarding the usage of RSS data or web pages from the second generation on are performed through the link destination processing setting screen HG2. The details of those settings are then indicated in the link destination processing setting information DTL. Furthermore, the link destination setting ID of the link destination, or in other words, of the RSS data or web page of the following generation, is indicated in the link destination processing setting information DTL.

The registered root processing setting information DTR can also be altered or deleted through the root RSS processing setting screen HG1. When the user presses a browse button 83, the image forming device 1 displays a list of root processing setting information DTR registered in the setting information storage portion 1K1. Here, the user selects the root processing setting information DTR s/he wishes to alter or delete. Upon doing so, the image forming device 1 redisplays the root RSS processing setting screen HG1 in a state in which the details of the selected root processing setting information DTR are indicated.

When the user presses a delete button 84, the image forming device 1 deletes the root processing setting information DTR from the setting information storage portion 1K1. At this time, the link destination processing setting information DTL associated with the root processing setting information DTR may also be deleted. Alternatively, if the user presses the register button 80 after altering the details, the image forming device 1 re-registers the root processing setting information DTR including the altered details in the setting information storage portion 1K1.

Alteration or deletion of the link destination processing setting information DTL can be performed in a similar manner through the link destination processing setting screen HG2.

The configuration may be such that the setting operations described thus far can be remotely performed through a terminal device such as the terminal device 21, the mobile phone terminal 31, or the terminal device 32. In this case, for example, CGI (Common Gateway Interface) functionality may be installed in the image forming device 1, and web page data for reproducing screens similar to the root RSS processing setting screen HG1 and link destination processing setting screen HG2 may be prepared. The user may then access the image forming device 1 through a web browser in the terminal device, display the appropriate screens, and perform the settings. Alternatively, the user may perform the settings by sending an e-mail, in which the details of the settings are written, from the terminal device to the image forming device 1.

Returning to FIG. 2, the download processing portion 102 performs processing for downloading and obtaining RSS data or a web page from the web server 4 based on the root processing setting information DTR or link destination processing setting information DTL stored in the setting information storage portion 1K1.

For example, in the case where the URL “http://www.example1.xxx/index.rdf” is indicated in the root processing setting information DTR as the URL from which a page/data is to be obtained, the web server 4 belonging to the domain “example1.xxx” and having a server name of “www” is accessed, and an RSS file (RSS data) having a file name of “index.rdf” is downloaded.

Furthermore, in the case where the URL “http://www2.example13.yyy/news.html” is indicated in the link destination processing setting information DTL, the web server 4 belonging to the domain “example13.yyy” and having a server name of “www2” is accessed, and data for reproducing a web page, including an HTML file having a file name of “news.html”, the associated image files, and so on, is downloaded collectively. Hereinafter, this data shall be collectively referred to as “web page data”.

The download processing performed by the download processing portion 102 is performed periodically (for example, at a predetermined time each day).

The RSS data and web page data obtained by the download processing portion 102 is associated with the URL from which it was obtained (the supply source), the date/time when it was obtained, and so on, and is stored in the site data storage portion 1K2. In the case where RSS data or web page data obtained based on an identical URL is already stored in the site data storage portion 1K2, the older data is deleted, and the newly downloaded data is stored.

The update presence/absence determination portion 103 determines whether or not updated or newly-added items are included in the RSS data downloaded by the download processing portion 102. This determination may be performed based on the publication date/time, update date/time, or the like per item in the RSS data.

In the case where updated or newly-added items are included in the RSS data downloaded by the download processing portion 102, the updated item notification processing portion 106 performs processing for notifying the user thereof, in the following manner.

When root RSS data is downloaded by the download processing portion 102, it is checked whether or not updated items or newly-added items are present in the root RSS data.

Then, if such an item is present in the root RSS data, an e-mail EM1, in which the presence of the updated items or the newly-added items is denoted, is sent to the notification destination e-mail address indicated in the root processing setting information DTR of the root RSS data (see FIG. 6). Information for identifying the root RSS data, such as a root setting ID, is associated with the e-mail EM1.

Note that the e-mail EM1 is sent in the case where a “pre-start notification” flag in the root processing setting information DTR is set to “on”. The e-mail EM1 is not sent if this flag is “off”. Furthermore, in the case where a “post-processing select” flag is “on”, screen data GD1, for a screen through which the method of executing the post-processing is selected, is attached to the e-mail EM1, and the e-mail EM1 is sent.

Alternatively, the updated items or newly-added items may be extracted from the root RSS data, attached to the e-mail EM1, and sent to the notification destination e-mail address.

As yet another alternative, in the case where the root RSS data has RSS data or web pages from the second generation on, the notification may also be performed when the RSS data or web pages include updated items or newly-added items.

The terminal device that receives the e-mail EM1, such as the terminal device 21, mobile phone terminal 31, or terminal device 32, displays the details of the e-mail EM1.

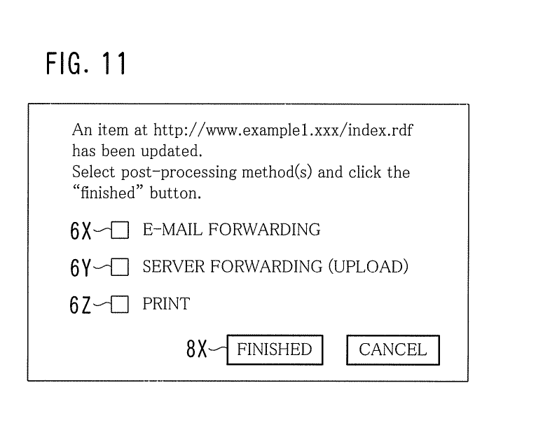

In the case where screen data GD1 is attached to the e-mail EM1, a screen in which check boxes 6X, 6Y, and 6Z used for selection are disposed, such as that shown in FIG. 11, is displayed. The user sets the check box corresponding to the processing method s/he desires to be used to “on” and presses a finished button 8X.

Upon doing so, the terminal device sends processing selection information PS1, indicating the selected (specified) processing method as well as a root setting ID of the RSS data, to the image forming device 1.

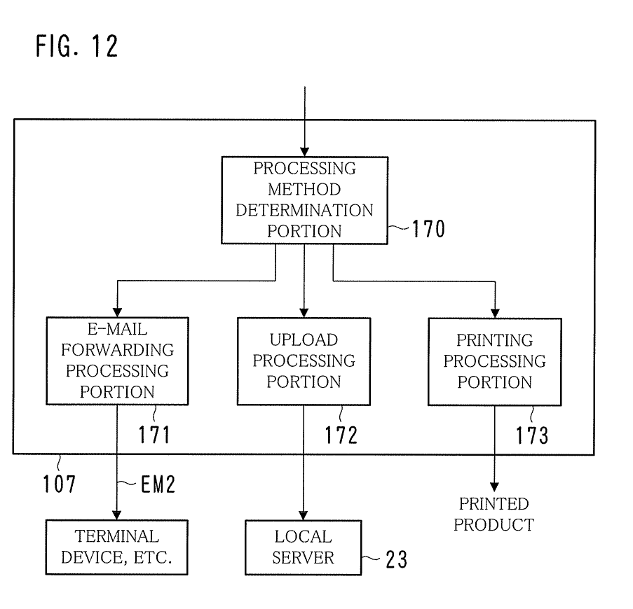

The post-processing portion 107 is, as shown in FIG. 12, configured of a processing method determination portion 170, an e-mail forwarding processing portion 171, an upload processing portion 172, and a printing processing portion 173, and performs processing for using RSS data and web page data downloaded by the download processing portion 102, or in other words, post-processing.

When the update presence/absence determination portion 103 checks that updated items or newly-added items are present in the downloaded RSS data, the processing method determination portion 170 determines the usage method of the root RSS data in the following manner.

As a general rule, the processing method determination portion 170 acts in accordance with the values of “mail forward”, “server forward (upload)”, and “print” flags found in the root processing setting information DTR (see FIG. 6) of the root RSS data. In other words, the method according to the flag that is set to “on” is determined to be the usage method for the root RSS data.

However, in the case where the “post-processing selection” flag in the root processing setting information DTR is set to “on”, the processing method determination portion 170 acts in accordance with the processing selection information PS1 from the terminal device 21 or the like regarding the root RSS data. In other words, the method selected by the user that received the notification that an update or the like has occurred (the e-mail EM1) is determined to be the usage method for the root RSS data. Alternatively, the method for which a flag is set to “on” and which is selected by the user may be determined to be the usage method for the root RSS data.

The e-mail forwarding processing portion 171 sends (forwards) an e-mail EM2, to which the root RSS data is attached, to the notification destination e-mail address indicated in the root processing setting information DTR. In the case where plural e-mail forwarding destination e-mail addresses are present, the e-mail EM2 is sent to each of the addresses. However, in the case where the first keyword has been set, the root RSS data is edited so that items or content not related to the keyword are deleted while items or content related to the keyword are left intact, and the resultant is attached to the e-mail EM2.

The upload processing portion 172 transfers and uploads the root RSS data to the local server 23 in accordance with an upload destination path indicated in the root processing setting information DTR. However, in the case where the second keyword has been set, the root RSS data is edited so that items or content not related to the keyword are deleted while items or content related to the keyword are left intact, and the resultant is uploaded.

The printing processing portion 173 controls the printing unit 10g so as to print items onto paper in accordance with the root RSS data. However, in the case where the third keyword is set, items related thereto are printed, while items not related thereto are not printed. The printing processing may be performed as soon as it is detected that an item in the root RSS data has been updated or a new item has been added to the root RSS data, or may be performed the next time the user having the user ID indicated in the root processing setting information DTR logs onto the image forming device 1.

Note that in the case where the root RSS data has RSS data or web page data of the second generation on, the e-mail forwarding processing portion 171, upload processing portion 172, and printing processing portion 173 attach the data to an e-mail EM2 and send (forward) the e-mail, upload the data, or print the data, respectively, based on the respective link destination processing setting information DTL, in the same manner as with the root RSS data.

The execution status notification processing portion 108 notifies the user, who has the user ID indicated in the root processing setting information DTR of the root RSS data undergoing post-processing, of the execution status of the post-processing performed by the post-processing portion 107 via e-mail. This user's e-mail address can be found by referring to the user information storage portion 1K0.

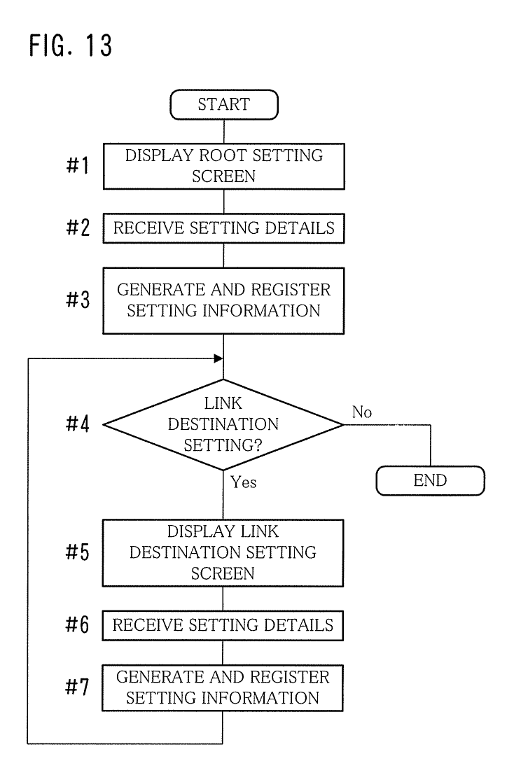

Next, the overall flow of processing performed by the image forming device 1 shall be described with reference to the flowcharts of FIGS. 13 to 15.

Note that the processing illustrated in these flowcharts is implemented by a program stored in a recording medium, such as the hard disk 10d of the image forming device 1, being executed by the CPU 10a.

In FIG. 13, when a logged-on user inputs a predetermined command, the image forming device 1 displays the root RSS processing setting screen HG1 such as that shown in FIG. 8 (#1). Here, in addition to a URL indicating the location where the desired RSS data is obtained from (the supply source), the user specifies the notification method for a case where items have been added to or updated in the RSS data, and the usage method for that RSS data, or in other words, the post-processing method.

Upon receiving the specified details from the user (#2), the image forming device 1 generates the root processing setting information DTR and registers it in the setting information storage portion 1K1 (#3).

In the case where the user wishes to use RSS data or web page data of the second generation on from the original RSS data (the root RSS data) (Yes in #4), the image forming device 1 displays the link destination processing setting screen HG2, such as that shown in FIG. 10 (#5). Here, the user specifies the usage method for each piece of RSS data and web page data, or in other words, specifies the post-processing method.

Upon receiving the specified details from the user (#6), the image forming device 1 generates the link destination processing setting information DTL and registers it in the setting information storage portion 1K1 (#7). Furthermore, the link destination setting ID of each piece of link destination processing setting information DTL is reflected in the root processing setting information DTR or link destination processing setting information DTL of the RSS data or web page data of the previous generation.

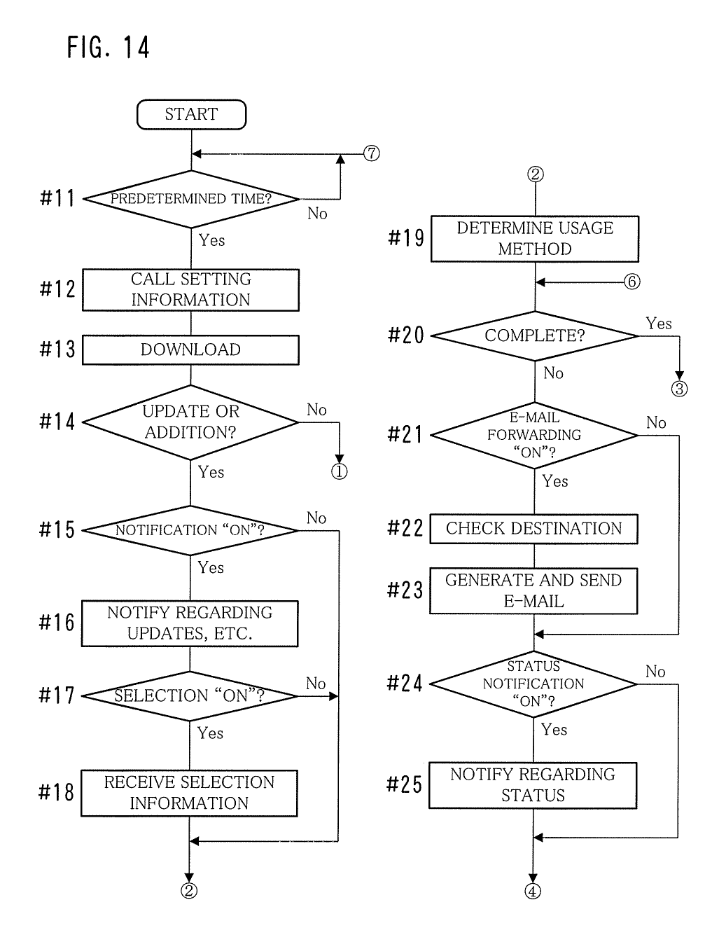

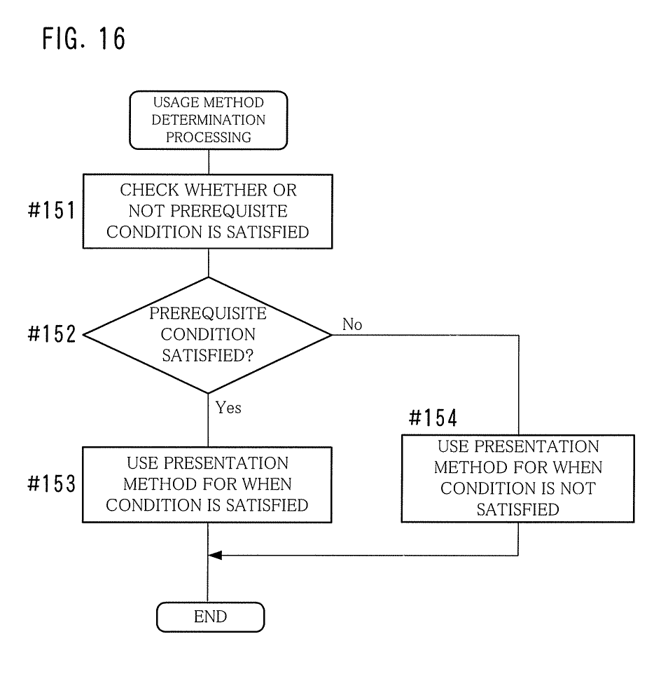

The image forming device 1 executes post-processing on each piece of root RSS data for which root processing setting information DTR is registered in the setting information storage portion 1K1, through a procedure such as that shown in FIG. 14 and FIG. 15. The example described hereinafter assumes the case where post-processing is carried out on a single piece of root RSS data DA.

In FIG. 14, each time a predetermined time is reached (Yes in #11), the image forming device 1 calls root processing setting information DTR, such as that shown in FIG. 6, of the root RSS data DA (#12), and carries out notification processing and post-processing in the following manner.

The root RSS data DA is downloaded based on the URL from which the data is to be obtained as indicated in the root processing setting information DTR (#13). In the case where RSS data or web page data of the second generation on has been specified, that data is also downloaded based on the URLs indicated in the link destination processing setting information DTL (see FIG. 7).

It is checked whether or not items that have been updated or newly added since the last download time are present in the root RSS data DA (#14), and if such an item is present (Yes in #14), the necessary notification processing and post-processing are executed in order.

In the case where the “pre-start notification” flag in the root processing setting information DTR is “on” (Yes in #15), an e-mail EM1, for communicating the presence of an updated or added item, is sent to the notification destination e-mail address indicated in the root processing setting information DTR (#16). Note that in the case where the “post-processing selection” flag is “on”, the screen data GD1 is attached to the e-mail EM1, and the e-mail EM1 is sent.

The post-processing is executed in parallel with or before/after the notification processing (#19 to #38 in FIG. 15). However, in the case where the “post-processing selection” flag is “on” (Yes in #17), the post-processing is executed after the processing selection information PS1 indicating the post-processing method (in other words, the usage method of the root RSS data DA) selected by the user is received (#18).

The post-processing method is determined based on the values of the “mail forward”, “server forward (upload)”, and “print” flags found in the root processing setting information DTR (#19). However, in the case where the processing selection information PS1 has been received, the method is further limited to the methods selected by the user as indicated therein.

In the case where the method that forwards an e-mail has been selected (Yes in #21), the e-mail forwarding destination e-mail address indicated in the root processing setting information DTR is checked (#22), and an e-mail EM2 to which the root RSS data DA is attached is forwarded (sent) to that e-mail address (#23). Here, if the “execution status notification” flag is “on” (Yes in #24), the user is notified of the status of this forwarding (#25).

In the case where the method that uploads the data has been selected (Yes in #26 in FIG. 15), the upload destination path indicated in the root processing setting information DTR is checked (#27), and the root RSS data DA is uploaded by sending it to the web server 4 (#28). Here, if the “execution status notification” flag is “on” (Yes in #29), the user is notified of the status of this upload (#30).

In the case where the method that prints the data has been selected (Yes in #31), the system waits for a user to log on using the user ID indicated in the root processing setting information DTR (#32), and when that user has logged on (Yes in #33), the items indicated in the root processing setting information DTR are printed (#34). Here, if the “execution status notification” flag is “on” (Yes in #35), the user is notified of the status of this printing (#36).

Returning to #20 in FIG. 14, in the case where settings have been made regarding the use of RSS data or web pages from the second generation on (No in #20), processing for usage of these RSS data or web pages is also carried out as appropriate based on the respective pieces of link destination processing setting information DTL (see FIG. 7) (#21 to #36).

Note that forwarding, uploading, and printing may only be carried out for updated or newly-added items, if desired.

Once the post-processing for all RSS data and web pages that are to be used has been completed (Yes in #20), if the “completion notification” flag is “on” (Yes in #37), the user is notified that all post-processing has been completed (#38).

The processing from #11 to #38 described thus far is executed continuously for the period in which the root processing setting information DTR of the root RSS data DA remains (Yes in #39).

According to the present embodiment, a user can obtain and use RSS data and web pages publicized through a web server in a more efficient manner than conventionally possible.

Furthermore, the RSS data and web pages can also be forwarded via e-mail, uploaded to the local server 23 on the intranet 5, or printed. Accordingly, for example, a worker (user) working at an office where strict limitations are placed on network access to the exterior for security reasons can obtain RSS data and web pages s/he wishes to use through a method such as the following. While at the office, the user obtains the items by causing the image forming device 1 to print the items. Alternatively, the user obtains the items by accessing the local server 23. When the user is at home, s/he can obtain the items by using a personal computer installed at home to receive e-mails. When away from home, the user can obtain the items by using a mobile telephone terminal to receive e-mails.

Although in the present embodiment, the obtained RSS data or web pages are sent to the user, uploaded, or printed on a data-by-data or page-by-page basis, all linked RSS data and web pages (in other words, all items belonging to the same tree) may be sent, uploaded, or printed altogether.

In the present embodiment, the RSS data and the web page are used by the usage methods preset by the user uniformly. Alternatively, the user selects the usage method of the RSS data and the web page sequentially per use. However, the present embodiment may be configured so that the usage methods can be determined in accordance with various statuses. For example, the usage methods may be determined as follows.

A prerequisite condition is first set in advance. Usage methods for the cases that satisfy the prerequisite condition (denoted as “first usage methods” hereinafter) and usage methods for the cases that do not satisfy the prerequisite condition (denoted as “second usage methods” hereinafter) are determined. The details of these determinations may be written in the root processing setting information DTR or the link destination processing setting information DTL.

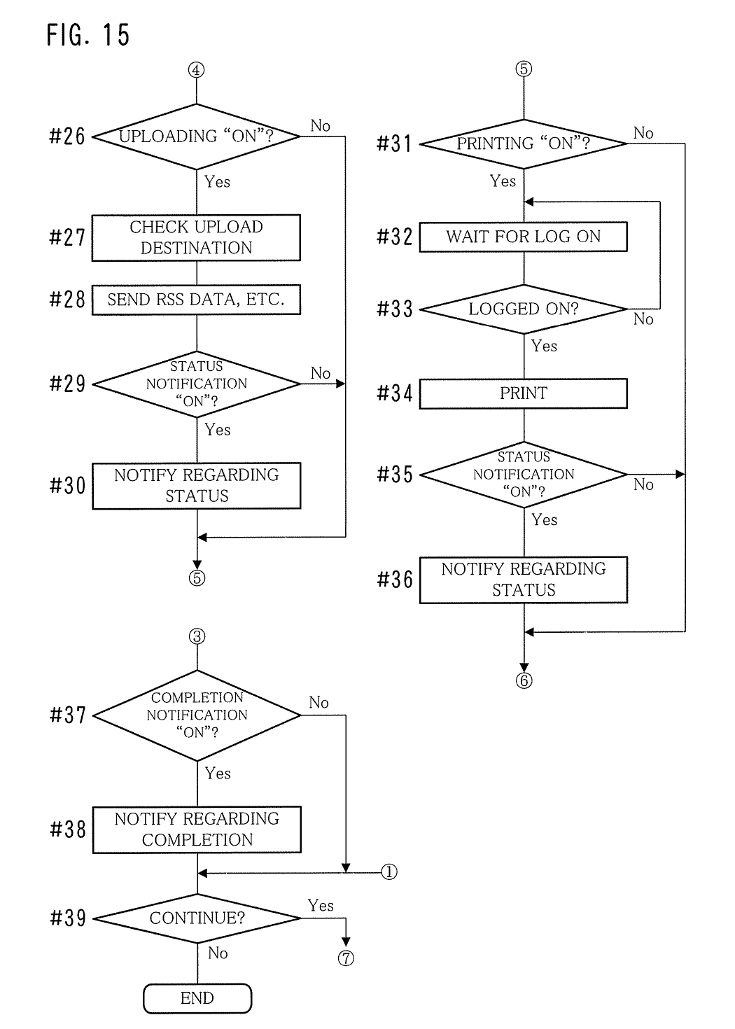

Then, the processing illustrated in step #19 of FIG. 14 is performed as indicated in FIG. 16. First, it is checked whether the prerequisite condition is satisfied (#151 in FIG. 16). In the case where the prerequisite condition is satisfied (Yes in #152), it is determined that the RSS data or web page will be used according to the first usage method (#153). In the case where the prerequisite condition is not satisfied (No in #152), it is determined that the RSS data or web page will be used according to the second usage method (#154).

A condition in which, for example, the update frequency of the RSS data or web page to be used is no greater than a set value can be used as the prerequisite condition. The update frequency is found by sequentially checking the update dates/times of RSS data or web pages obtained from the same URL up to that point in time and calculating the interval of the update dates/times.

In the present embodiment, a method through which the data is forwarded via e-mail, a method where the data is uploaded to the local server 23, and a method where the data is printed onto paper are selectively used as methods for using RSS data and web pages publicized through the web server 4. However, other methods aside from these may be made selectable as well.

For example, a method by which data is saved in a box (or directory, or folder) shared by members of the organization (users) and provided in the image forming device 1 may be made selectable.

The data may be uploaded to a different server than the local server 23, such as, for example, a server connected to another network aside from the intranet 5.

In the present embodiment, an integrated multi-function type image forming device 1, such as a multi-function peripheral or simply “MFP”, is used as the publicized information use apparatus. However, the publicized information use apparatus is not limited thereto. For example, the publicized information use apparatus may be a printer, scanner, facsimile, or the like that has network connectivity.

The root processing setting information DTR may be applied in common to data of the second generation and on.

Finally, it should be noted that various variations are possible for the configurations of all or part of the image forming device 1, the terminal devices 21 and 32, the local server 23, the mobile phone terminal 31, the web server 4, and the intranet 5; the processing content; the processing orders; the configuration of the root processing setting information DTR; the configuration of the link destination processing setting information DTL; the usage methods of the RSS data and web pages; and so on, without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A publicized information use apparatus for using publicized information, the publicized information being information publicized through a server, the apparatus comprising:
a storage portion that stores usage method information indicating a method by which each piece of the publicized information is to be used after being obtained;
an obtainment portion that obtains the publicized information from the server; and
a usage processing portion that executes usage processing based on the usage method information for the publicized information stored in the storage portion, the usage processing being processing for using the publicized information obtained by the obtainment portion.

2. The apparatus according to claim 1,
wherein the usage processing portion executes, as the usage processing, at least one of processing for forwarding the publicized information to a predetermined destination, processing for uploading the publicized information to a second server that manages information shared among a plurality of users, and processing for printing the publicized information onto paper.

3. The apparatus according to claim 1, further comprising:
a determination portion that determines whether or not content that has been updated or added is included in the publicized information obtained by the obtainment portion,
wherein the usage processing portion executes the usage processing in the case where the determination portion has determined that content that has been updated or added is included in the publicized information.

4. The apparatus according to claim 3,
wherein the usage processing portion executes the usage processing only for content that has been updated or added, from among the content included in the publicized information.

5. The apparatus according to claim 3, further comprising:
a notification portion that, in the case where the determination portion has determined that content that has been updated or added is included in the publicized information, provides, to a user, an update notification message indicating the presence of the updated or added content, and a selection prompt message prompting the user to select a usage method for the updated or added content,
wherein the usage processing portion executes processing using the usage method selected by the user in accordance with the selection prompt message as the usage processing.

6. The apparatus according to claim 1,
wherein the storage portion stores usage method information indicating a keyword as the usage method information, and
the usage processing portion executes the usage processing only for content accompanied with the keyword indicated in the usage method information of the publicized information, from among the content included in the publicized information.

7. The apparatus according to claim 1,
wherein in the case where the publicized information includes a link to different publicized information, the usage processing portion executes the usage processing on the different publicized information as well as on the publicized information.

8. The apparatus according to claim 1,
wherein the publicized information is written in an RSS format.

9. A publicized information use method for using publicized information, the publicized information being information publicized through a server, the method comprising: storing, in a storage device, usage method information indicating a method by which each piece of the publicized information is to be used after being obtained;
obtaining the publicized information from the server; and
executing usage processing based on the usage method information for the publicized information stored in the storage device, the usage processing being processing for using the obtained publicized information.

10. The method according to claim 9,
wherein at least one of processing for forwarding the obtained publicized information to a predetermined destination, processing for uploading the obtained publicized information to a second server that manages information shared among a plurality of users, and processing for printing the obtained publicized information onto paper is executed as the usage processing.

11. The method according to claim 9, further comprising:
determining whether or not content that has been updated or added is included in the obtained publicized information,
wherein the usage processing is executed on the obtained publicized information in the case where it has been determined that content that has been updated or added is included in the obtained publicized information.

12. The method according to claim 11,
wherein the usage processing performed on the obtained publicized information is executed only for content that has been updated or added, from among the content included in the obtained publicized information.

13. The method according to claim 11, further comprising:
providing to a user, in the case where it has been determined that content that has been updated or added is included in the obtained publicized information, an update notification message indicating the presence of the updated or added content, and a selection prompt message prompting the user to select a usage method for the updated or added content,
wherein processing using the usage method selected by the user in accordance with the selection prompt message is executed as the usage processing.

14. The method according to claim 9,
wherein usage method information indicating a keyword is stored in the storage device as the usage method information, and
the usage processing performed on the obtained publicized information is executed only for content accompanied with the keyword indicated in the usage method information of the obtained publicized information, from among the content included in the obtained publicized information.

15. The method according to claim 9,
wherein in the case where the obtained publicized information includes a link to different publicized information, the usage processing for the obtained publicized information is executed on the different publicized information as well as on the obtained publicized information.

16. The method according to claim 9,
wherein the publicized information is written in an RSS format.

17. A computer program product used by a computer that obtains publicized information, the publicized information being information publicized through a server, and that has a storage device that stores usage method information indicating a method by which each piece of the publicized information is to be used after being obtained, the product causing a computer to execute processing comprising:
obtaining the publicized information from the server; and
using the obtained publicized information based on the usage method information for the publicized information stored in the storage device.
